(19) United States
(12) Patent Application Publication
(10) Pub. No.: US 2003/0142095 A1
(43) Pub. Date: Jul. 31, 2003

(54) Displaying method to display statistical chart on scientific plotting type calculator and a calculator applied the like

(75) Inventors: Chung-Hung Chang, Taipei (TW); Pei-Chih Chen, Taipei (TW)

Correspondence Address: BRUCE H. TROXELL, 5205 LEESBURG PIKE, SUITE 1404, FALLS CHURCH, VA, 22041, US

(73) Assignee: Kinpo Electronics, Inc.

(21) Appl. No.: 10/059,019

(22) Filed: Jan. 30, 2002

(51) Int. Cl. G06T 11/20

(52) U.S. Cl. 345/440

(57) ABSTRACT

This invention relates to a method to display a statistical chart on scientific plotting type calculator, which is simulated a three-dimensional coordinates, with an axis X, an axis Y and a simulate axis T, to display several points represented as (x, y, t) on display screen. The way of this invention to display a simulated three-dimensional statistical chart on scientific plotting type calculator space is used several pairs of data as points constituted by series of X value and Y value, according magnitude in sequence of t value orderly to display those points and synchronously connected with line, to form a correlative statistical graph so that user can directly observe an interrelation between value of (x, Y) and t time value from display screen.

### BACKGROUND OF THE INVENTION

1. Field of the Invention

The present invention relates to a method to display a statistical chart on scientific plotting type calculator, and more particularly to the method capably to display statistical chart on calculator in way of simulated three-dimensional space.

2. Description of Related Art

The general type of scientific plotting calculator is provided with a liquid crystal display (LCD) to display statistical graphs or charts, but only two-dimensional space of statistical graphs or charts can be displayed on general type of scientific plotting calculator as shown in FIG. 1. For example, as axis T is represented as time value and axis Y is represented as event value respectively, then the points shown on graph of FIG. 1 are capably defined by series of T value and Y value, where T value is included t=0, 1, 2, 3 and 4, and Y value is included y=1, −1, 2, −1 and 1. In orderly connection with each point defined by t and y, i.e. point (t, y), may make a correlative graph as shown in FIG. 1.

In practical example, it is absolutely necessary to make a correlative graph defined by two events versus time such as according to the YIELD of a product, and DEFECT RATE of the product, versus PRODUCT TIME to make a three-dimensional correlative graph. Nevertheless, general type of scientific plotting calculator in function is without making a three-dimensional graph and in use sill not satisfies all user's needs or requirements.

### SUMMARY OF THE INVENTION

This present invention provides general type of scientific plotting calculator with function of capably making simulated three-dimensional statistical graphs or charts.

The primary objective of this present invention is to provide a method to display correlative graphs or charts in way of simulated three-dimensional space on general scientific plotting calculator.

The another objective of this present invention is to provide a scientific plotting calculator to display simulated three-dimensional statistical graphs or charts.

### BRIEF DESCRIPTION OF THE DRAWINGS

The invention is description in detail with reference to the following drawings, wherein like numerals represent like elements:

FIG. 1 is a two-dimensional statistical graph displayed by prior scientific plotting calculator.

FIG. 2 is a structural block diagram of the scientific plotting calculator of this invention.

FIG. 3 is a flow chart to execute the method of this invention.

FIG. 4 is a three-dimensional statistical graph displayed by scientific plotting calculator of this invention.

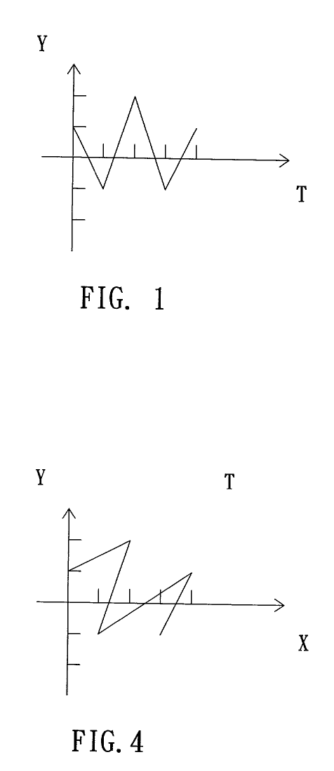

### DETAILED DESCRIPTION OF THE PREFERRED EMBODIMENT

Referring to FIG. 2, a scientific plotting calculator have applied to disclosed method of this invention comprises a CPU (Central Processing Unit) 10 respectively connected to an input unit 20, an output unit 30 and memory unit 40. Said CPU 10 has an I/O buffer (input/output buffer) 11 which is also connected to an input editor 12 and a graph/text converter 13. Said input editor 12 is connected to an algebraic logic counting unit 14 which is further connected to a time generator 15, a text display buffer 16, a data RAM 17 and a graph generator 18 respectively. Said graph/text converter 13 is connected to said time generator 15, said text display buffer 16 and a graph display buffer 19 respectively. Said graph generator 18 and said graph display buffer 19 are also connected together.

User can operate those keys of input unit 20 to key in three sets of series of X value, Y value and T value respectively, where X value is included x=x₁, x₂ X₃˜xₙ, Y value is included y=y₁, y₂y₃˜yₙ, and T value is included t=t₁, t₂ t₃˜tₙ, and a simulated three-dimensional graph will be displayed in display screen of LCD once those input series of value of X, Y, and T have been completed operational analysis with said algebraic logic counting unit 14, said time generator 15, said graph/text converter 13 and said graph generator 18 of Said CPU 10. And said three set of series of X value, Y value and T value formed as a simulated three-dimensional graph displayed may be wholly saved in said memory 40.

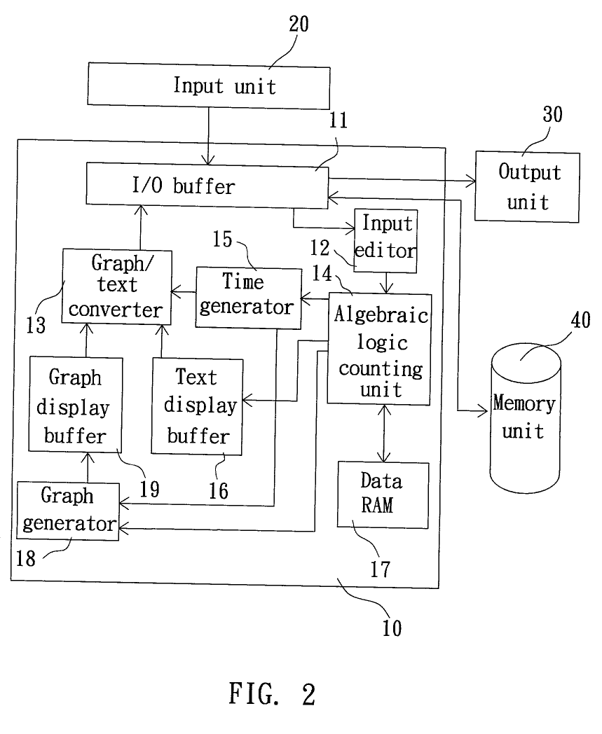

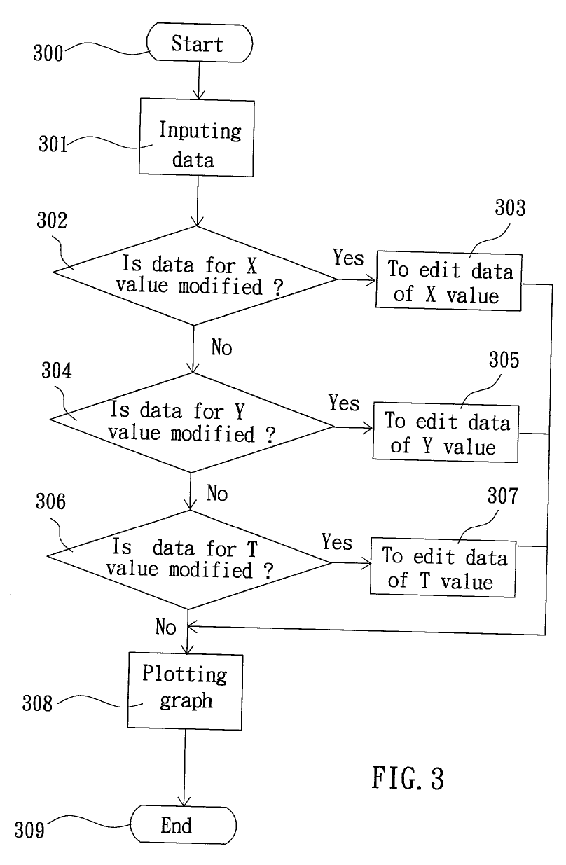

Referring to FIG. 2, FIG. 3 and FIG. 4, the method of this invention used to display a simulated three-dimensional graph on scientific plotting calculator comprises the following steps:

301 CPU 10 has detected a series of relevant data information about X value, Y value and T value transferred from said input unit 20 and saved those relevant data information;

302 CPU 10 makes a decision whether has detected modified data to series of X value transferred from said input unit 20;

303 executing edition operation to series of X value, if any modified data to series of X value transferred from said input unit 20 have already detected with said CPU 10;

304 CPU 10 makes a decision whether has detected modified data to series of Y value transferred from said input unit 20;

305 executing edition operation to series of Y value, if any modified data to series of Y value transferred from said input unit 20 have already detected with said CPU 10;

306 CPU 10 makes a decision whether has detected modified data to series of T value transferred from said input unit 20;

307 executing edition operation to series of T value, if any modified data to series of T value transferred from said input unit 20 have already detected with said CPU 10;

308 CPU 10 according magnitude in sequence of t value orderly displays each (x, y, t) data of input series of X value, Y value and T value on display screen of LCD of output unit 30, and synchronously in sequence connects each point (represented by (x, y)) shown on display screen with line to completely form and display a simulated three-dimensional graph.

In step 301, said series of relevant data information about X value, Y value and T value transferred from said input unit 20 also comprises data information are immediately input by user or other kind of data information pre-saved in said memory unit 40 and output therefrom due to being instructed from said input unit 20.

Referring to FIG. 4, the points shown on this embodiment of this invention is defined by series of X value, Y value and T value, where X value is included x=0, 1, 2, 3 and 4, Y value is included y=1, −1, 2, −1 and 1, and T value is included t=5, 3, 4, 1 and 2. The correlative graph of this invention, according magnitude in sequence of t value to display each point (x, y, t) and orderly connecting each point with line, capably displays the interrelation in between x value and y value versus t value. In this embodiment shown in FIG. 4, point 1 represented by t=! and (x, y)=(3, −1) is firstly displayed; then point 2 represented by t=2 and (x, y)=(4, 1) is secondly displayed, and said two points mentioned above are connected with line; further, point 3 represented by t=3 and (x, y)=(1, −1) is displayed and said point 2 and point 3 are connected with line too; continuously doing point 4 of t=4 and point 5 of t=5 the same way by analogy, therefore, a simulated three-dimensional graph shown in FIG. 4 can be completely displayed. If said t value is represented as time, said simulated three-dimensional graph shown in FIG. 4 represented as a correlative graph of point (x, y) versus time t can be directly observed by user. If by trace mode to display each point shown on display screen, according the magnitude order of t value to display point (x, y), the display order of points are (3, −1), (4, 1), (1, −1), (2, 2) and (0, 1).

The method of this disclosed invention may display a correlatively statistical graph represented as two correlative events versus time so that this method to display a simulated three-dimensional statistical graphs on scientific plotting type calculator can totally promote useful function to scientific plotting type calculator.

The scope of this disclosed invention is not limited to the embodiment illustrated as above. Which scope explained and defined by claims may include all changeable equivalents more particularly only changed in easy amendment or variation.

What is claimed is:

1. A method to display a statistical chart on scientific plotting type calculator, comprises steps of:
(a) CPU has detected a series of relevant data information about X value, Y value and T value transferred from an input unit and saved those relevant data information; and
(b) Said CPU according magnitude in sequence of t value orderly displays each (x, y, t) data of input series of X value, Y value and T value on display screen of an output unit, and synchronously in sequence connects each point (represented by (x, y)) shown on display screen with line to completely form and display a simulated three-dimensional graph.

2. The method to display a statistical chart on scientific plotting type calculator as defined by claim 1, wherein in between step (a) and step (b)further comprises a step of:
said CPU makes a decision whether has detected modified data to series of X value transferred from said input unit; and executing edition operation to series of X value, if any modified data to series of X value transferred from said input unit have already detected with said CPU.

3. The method to display a statistical chart on scientific plotting type calculator as defined by claim 1, wherein in between step (a) and step (b)further comprises a step of:
said CPU makes a decision whether has detected modified data to series of Y value transferred from said input unit; and executing edition operation to series of Y value, if any modified data to series of Y value transferred from said input unit have already detected with said CPU.

4. The method to display a statistical chart on scientific plotting type calculator as defined by claim 1, wherein in between step (a) and step (b)further comprises a step of:
said CPU makes a decision whether has detected modified data to series of T value transferred from said input unit; and executing edition operation to series of T value, if any modified data to series of T value transferred from said input unit have already detected with said CPU.

5. The method to display a statistical chart on scientific plotting type calculator as defined by claim 1, wherein in step (a) which a series of relevant data information about X value, Y value and T value transferred from said input unit may be immediately input.

6. The method to display a statistical chart on scientific plotting type calculator as defined by claim 1, wherein in step (a) which a series of relevant data information about X value, Y value and T value transferred from said input unit may be a kind of data information pre-saved in said memory unit and output therefrom due to being instructed from said input unit.

7. A scientific plotting calculator is capably to execute the method as defined by claim 1, comprises a CPU respectively connected to an input unit, an output unit and memory unit; wherein said CPU has an I/O buffer (input/output buffer) connected to an input editor and a graph/text converter; said input editor is connected to an algebraic logic counting unit which is further connected to a time generator, a text display buffer, a data RAM and a graph generator respectively; said graph/text converter is connected to said time generator, said text display buffer and a graph display buffer respectively; and said graph generator is connected to said graph display buffer.
